(19) United States
(12) Patent Application Publication
(10) Pub. No.: US 2026/0257801 A1
(43) Pub. Date: Sep. 3, 2026

(54) ELECTRICAL DISTRIBUTION SYSTEM FOR AIRCRAFT AND ASSOCIATED METHOD

(71) Applicant: SAFRAN ELECTRICAL & POWER, BLAGNAC (FR)

(72) Inventors: Vincent CHAPERON, MOISSY-CRAMAYEL (FR); Florence GIRAULT, MOISSY-CRAMAYEL (FR)

(21) Appl. No.: 18/871,639

(22) PCT Filed: Jun. 15, 2023
(86) PCT No.: PCT/EP2023/066177

§ 371 Date: Dec. 4, 2024

(30) Foreign Application Priority Data
Jun. 21, 2022 (FR) FR2206118

(51) Int. Cl. B64D 27/34; B60L 3/00; B60L 15/00; B60L 50/50

(52) U.S. Cl. CPC B64D 27/34; B60L 3/0046; B60L 3/0092; B60L 15/007; B60L 50/50; B60L 2200/10; B60L 2210/42

(57) ABSTRACT

An electrical distribution system configured to supply power to at least a first electric motor and a second electric motor from at least a first electrical source and a second electrical source, including at least a first switch and a second switch, each switch including at least a first power supply bus and a second power supply bus, at least one electrical reconfiguration line connecting the first switch to the second switch, the electrical reconfiguration line including at least one reconfiguration switch configured to be switched into the closed position in the event of a fault in one of the electrical sources.

### TECHNICAL FIELD

The present invention relates to an electrical distribution system configured to supply power to a plurality of electric propulsion motors for an aircraft from a plurality of electrical sources. The present invention relates in particular to a segregated electrical distribution system allowing the propulsion of the aircraft to be ensured in the event of a fault in one of the electrical sources.

The climate change is a major concern for many legislative and regulatory members around the world. Various restrictions on carbon emissions have been, are being or will be adopted by various states. In particular, an ambitious standard applies both to new types of aircrafts and to those already in circulation, requiring the implementation of technological solutions so as to bring them into line with current regulations. For several years now, the civil aviation has been working to help combat climate change.

Technological research efforts have already led to significant improvements in the environmental performance of the aircrafts. The Applicant takes into account important factors in all phases of design and development to obtain aeronautical elements and products that consume less energy, are more environmentally friendly and whose integration and use in the civil aviation have moderate environmental consequences with the aim of improving the energy efficiency of the aircrafts.

Consequently, the Applicant is constantly working to reduce its negative impact on the climate by employing methods and using development and manufacturing methods that are virtuous and minimize greenhouse gas emissions to the minimum possible in order to reduce the environmental footprint of its business.

This sustained research and development work covers both new generations of aircraft motors and the use of electrical technologies for propulsion.

As is well known, with reference to FIG. 1, an aircraft comprises four electric motors M11-M14 to allow its propulsion, power supplied by two electrical batteries B11, B12 via an electrical distribution system 100. In this example, the electrical distribution system 100 comprises a first electrical commutator C11 connected, on the one hand, to the first electrical battery B11 and, on the other hand, to two propulsion motors M11, M12. The electrical distribution system 100 also comprises a second electrical commutator C12 connected, on the one hand, to the second electrical battery B12 and, on the other hand, to two other propulsion motors M13, M14.

In a known way, each electrical battery B11, B12 has a large power for supplying power to the motors M11-M14. This requires the use of specific expensive cables between an electrical battery B11, B12 and its associated commutator C11, C12, which is an economic disadvantage. In addition, at high voltages, there is a greater risk of an electrical fault (electric arc, etc.).

Furthermore, in order to ensure the supply of power to the electric motors M11-M14 in the event of a localized fault, it has been proposed to use an electrical distribution system 100 with an architecture referred to as “segregated” architecture, i.e. allowing the electrical batteries B11, B12 to take over from each other in the event of a fault by isolating one or more electrical lines of the electrical distribution system 100. The first commutator C11 is connected to the second electrical battery B12 by a first electrical reconfiguration line R1. Similarly, the second commutator C12 is connected to the first electrical battery B11 by a second electrical reconfiguration line R2. The electrical reconfiguration lines R1, R2 are preferably unidirectional and only allow a current to flow in one direction so as to avoid simultaneous faults to appear. These reconfiguration lines R1, R2 also require the use of expensive special cables, which is also a disadvantage.

The invention aims to eliminate at least some of these disadvantages.

### PRESENTATION OF THE INVENTION

The invention relates to an electrical distribution system configured to supply power to at least a first electric motor and a second electric motor from at least a first electrical source and a second electrical source, each electric motor being a propulsion motor of an aircraft, each electric motor comprising at least a first electrical star and a second electrical star configured to be independently power supplied, each electrical source having a defined nominal power, each electrical source comprising at least a first power supply output and a second power supply output having a defined elementary power lower than the defined nominal power, the electrical distribution system comprising:
At least a first commutator and a second commutator, each commutator being associated with an electrical source and an electric motor,
Each commutator comprises at least a first power supply bus and a second power supply bus configured to supply power respectively to the first electrical star and the second electrical star of the electric motor associated with the commutator,
The first power supply bus and the second power supply bus of each commutator being configured to be power supplied respectively by the first power supply output and by the second power supply output of the electrical source associated with the commutator, the power supply buses being power supplied independently with the elementary power,
At least one electrical reconfiguration line connecting the first commutator to the second commutator, the electrical reconfiguration line comprising at least one reconfiguration switch configured to be active in the closed position in the event of a fault in one of the electrical sources.

Thanks to the invention, the nominal power of an electrical source may advantageously be distributed over several power supply buses so as to supply several electrical stars of an electric motor in a segregated manner. This improves the redundancy of the distribution system. Moreover, the power supply buses are connected by conventional electrical lines, so there's no need for specific electrical lines dedicated to high power, which are expensive and prone to electrical faults.

Each electrical source has a defined nominal power, and each electrical source comprises at least a first power supply output and a second power supply output with a defined elementary power that is lower than the defined nominal power. In other words, each output is not adapted to pass the entire nominal power via a single output, which is limited to an elementary power.

Preferably, the electrical distribution system comprises at least one parking supply line, connected to the electrical reconfiguration line, configured to allow the electrical sources to be recharged via the commutators connected to the electrical reconfiguration line. Advantageously, the electrical sources may be recharged conveniently by taking advantage of the reconfiguration line to allow the electrical sources to be recharged together.

Preferably, the electrical reconfiguration line comprises at least two reconfiguration switches, the parking supply line being connected between the two reconfiguration switches. The control of the configuration switches allow the one or the other of the electrical sources or both may be recharged simultaneously.

Preferably, each power supply bus is configured to be power supplied by a power supply output via an electrical source line. In one aspect, each electrical source line comprises at least one source switch so as to allow the power supply output to be isolated.

In another aspect, each source line is free of source switches. The power supply bus is connected directly, reducing the number of switches. The electrical isolation is provided directly by the power supply bus, which may be disabled.

Preferably, each power supply bus is configured to supply power to an electrical star via an electrical charge line. Each electrical charge line comprises at least one electrical management device configured to allow, on the one hand, an electrical supply to the electrical star by the associated power supply bus and, on the other hand, an electrical power supply for supplying power to the power supply bus by the associated electrical star.

Preferably, the electrical management device comprises at least two pairs of switches that may be controlled in a coordinated manner. At least one of the controllable switches is configured to limit the current draw during commutation.

Preferably, the electrical distribution system comprises a converter mounted between a commutator and its associated electric motor. This allows the electrical stars of the electric motor to be supplied with alternating current via a DC electrical source.

Preferably, the power supply buses of the same commutator are isolated from each other. This allows to limit the number of switches by segregating them within the same commutator.

Preferably, the distribution system comprises only two power supply buses per commutator.

The invention also relates to an electrical architecture for an aircraft comprising at least a first electric motor and a second electric motor, at least a first electrical source and a second electrical source, each electric motor being a propulsion motor for an aircraft, each electric motor comprising at least a first electrical star and a second electrical star configured to be independently power supplied, each electrical source having a defined nominal power, each electrical source comprising at least a first power supply output and a second power supply output having a defined elementary power less than the defined nominal power, the architecture comprising at least one electrical distribution system, as previously presented, supplying power to the electrical motors from the electrical sources.

Preferably, the sum of the elementary powers of the power supply outputs of an electrical source is greater than the nominal power of said electrical source. This means that if a power supply output and/or a power supply bus is faulty, more than 50% of the power may transit via a power supply output (in the case of two power supply outputs). This allows to supply several electrical stars while maintaining traditional electrical lines. Preferably, the nominal power is at least 400 kW. Preferably, the elementary power is less than 300 kW, preferably greater than 200 kW.

Preferably, the architecture comprises only two electrical sources.

The invention relates to a method for supplying power to at least a first electric motor and a second electric motor from at least a first electrical source and a second electrical source via an electrical distribution system as previously disclosed, each electric motor being an aircraft propulsion motor, each electric motor comprising at least a first electrical star and a second electrical star configured to be power supplied independently, each electrical source having a defined nominal power, each electrical source comprising at least a first power supply output and a second power supply output having a defined elementary power lower than the defined nominal power, the electrical sources being operational, the reconfiguration switch being open so as to electrically isolate the commutators, the supply method comprising steps consisting in:
For each commutator, supplying power respectively to the first power supply bus and the second power supply bus via the first power supply output and via the second power supply output of the electrical source associated with the commutator,
For each commutator, supplying power respectively to the first electrical star and the second electrical star of the electric motor associated with the commutator by the first power supply bus and the second power supply bus associated with the commutator,
If one of the electrical sources fails, closing the reconfiguration switch to electrically connect the commutators.

The invention also applies to a method for recharging the electrical sources by the motors via the distribution system, the recharging method comprising steps consisting in:
for each commutator, supplying power respectively to the first power supply bus and the second power supply bus with the first electrical star and the second electrical star of the electric motor associated with the commutator,
for each commutator, supplying power respectively to the first power supply output and the second power supply output of the electrical source associated with the commutator via the first power supply bus and the second power supply bus associated with the commutator.

### PRESENTATION OF FIGURES

The invention will be better understood on reading the following description, given by way of example, with reference to the following figures, given by way of non-limiting examples, wherein identical references are given to similar objects.

FIG. 1 is a schematic representation of an electrical distribution system with a segregated architecture according to the prior art.

FIG. 2 is a schematic representation of an electrical distribution system with a segregated architecture according to a first embodiment of the invention.

FIG. 3 is a schematic representation of an electrical distribution system with a segregated architecture according to a second embodiment of the invention.

FIG. 4 is a schematic representation of an electrical distribution system with a segregated architecture according to a third embodiment of the invention.

It should be noted that the figures set out the invention in detail in order to implement the invention, said figures of course being able to be used to better define the invention if necessary.

### DETAILED DESCRIPTION OF THE INVENTION

We will now present an aircraft comprising an electrical architecture to ensure the propulsion of the aircraft.

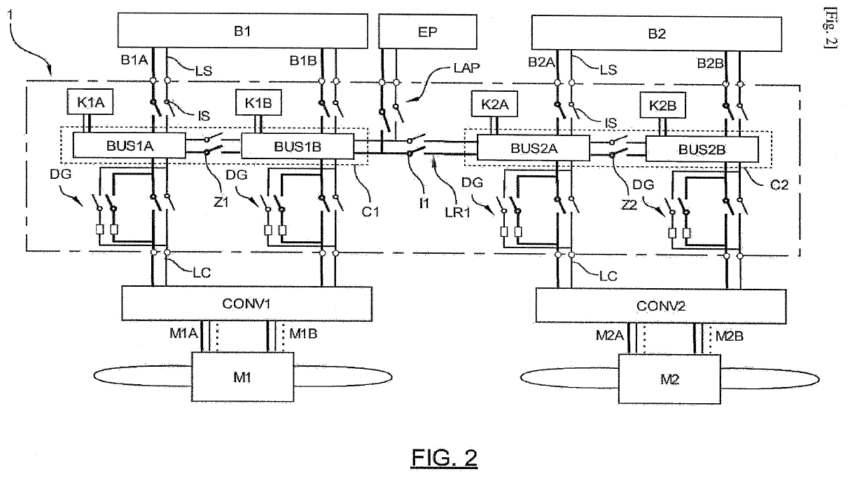

With reference to FIG. 2, an electrical architecture is shown comprising a first electric motor M1 and a second electric motor M2 for propelling the aircraft. However, the invention is applicable to more than two electric motors M1, M2, in particular four or six. Each electric motor M1, M2 comprises at least a first electrical star M1A, M2A and a second electrical star M1B, M2B configured to be independently power supplied. The electrical stars together form a stator of an electric motor M1, M2. Preferably, the first electric motor M1 comprises only a first electrical star M1A and a second electrical star M1B. Preferably, the first electric motor M1 comprises only a first electrical star M1A and a second electrical star M1B. Similarly, the second electric motor M2 comprises only a first electrical star M2A and a second electrical star M2B. In this example, the electrical stars of an electric motor M1, M2 are used to generate independent magnetic fields so as to drive a rotor of an electric motor M1, M2. The use of such electric motors M1, M2 advantageously allows operation in a degraded mode, as will be described later.

In order to supply power to the electric motors M1, M2, again with reference to FIG. 2, the electrical architecture comprises a first electrical source B1 and a second electrical source B2. It is preferable to use only two electrical sources B1, B2 but the invention nevertheless applies to more than two electrical sources B1, B2, in particular four.

Each electrical source B1, B2 has a defined nominal power Pnom. Preferably, each electrical source B1, B2 is an electrical battery or a fuel cell with a high voltage, in particular of the order of 800 Vdc. Preferably, the nominal power Pnom is of the order of 400 kW.

Still referring to FIG. 2, each electrical source B1, B2 comprises a first power supply output B1A, B2A and a second power supply output B1B, B2B having a defined elementary power Pele which is less than the defined nominal power Pnom. It is preferred to use only two power supply outputs per electrical source B1, B2 but the invention nevertheless applies to more than two power supply outputs. The use of several power supply outputs allows to distribute the nominal power Pnom of the electrical source B1, B2 and thus to transmit elementary powers Pele which are lower and simpler to transmit with traditional electrical lines.

Preferably, the sum of the elementary powers Pele of an electrical source B1, B2 is greater than the nominal power Pnom of said electrical source B1, B2 (Pele>Pnom). This means that if one power supply output fails, the other power supply output or the others power supply outputs may be used to supply a significant amount of power to the electric motors M1, M2. The propulsion thus remains satisfactory in a degraded mode. In this example, the elementary power Pele is greater than 200 kW, preferably less than 300 kW and even more preferably equal to 250 KW. This allows to transmit more than half the nominal power Pnom via a single power supply output, while using conventional electrical lines,

Preferably, each electric motor M1, M2 is configured to be power supplied with nominal power Pnom, in this example 400 kW.

According to the invention, the electrical architecture comprises an electrical distribution system 1 configured to transfer electrical power between the electrical sources B1, B2 and the electric motors M1, M2. This energy transfer is preferably bidirectional to allow the electrical sources B1, B2 to be recharged via the electric motors M1, M2 (generator mode).

With reference to FIG. 2, the electrical distribution system 1 comprises a first commutator C1 and a second commutator C2, each commutator C1, C2 being associated with an electrical source B1, B2 and an electric motor M1, M2. In particular, the first commutator C1 is associated with the first electrical source B1 and to the first electric motor M1. The second commutator C2 is associated with the second electrical source B2 and the second electric motor M2. There should preferably be as many commutators as there are electrical batteries.

In this example, a converter CONV1, CONV2 is fitted between each commutator C1, C2 and its associated electric motor M1, M2. Each converter CONV1, CONV2 is preferably of the continuous-alternating type. With reference to FIG. 2, each converter CONV1, CONV2 is independent of the electric motor M1, M2 and external to the electrical distribution system 1. Each converter CONV1, CONV2 could be directly integrated into said electric motor M1, M2. In addition, each converter CONV1, CONV2 could belong directly to the electrical distribution system 1.

In this example, each commutator C1, C2 comprises a first power supply bus BUS1A, BUS1B and a second power supply bus BUS2A, BUS2B configured to supply power respectively to the first electrical star M1A, M2A and the second electrical star M1B, M2B of the electric motor M1, M2 associated with the commutator C1, C2. It is preferable to use two power supply buses per commutator, but the invention is nevertheless applicable to more than two power supply buses. The number of power supply buses is preferably the same as the number of power supply outputs from the electrical source B1, B2 associated and that the number of electrical stars of the associated electric motor M1, M2 so as to maximize the distributed power.

The first power supply bus BUS1A, BUS1B and the second power supply bus BUS2A, BUS2B of each commutator C1, C2 are configured to be power supplied respectively by the first power supply output B1A, B2A and by the second power supply output B1B, B2B of the electrical source B1, B2 associated with the commutator C1, C2. This means that the power supply buses BUS1A, BUS1B, BUS2A, BUS2B are power supplied independently. The power supply buses BUS1A, BUS1B, BUS2A, BUS2B are power supplied with the elementary power Pele.

With reference to FIG. 2, each power supply bus BUS1A, BUS1B, BUS2A, BUS2B is configured to power supply to an electrical star M1A, M1B, M2A, M2B via an electrical charge line LC. In this example, in order to allow a bidirectional energy transfer, each electrical charge line LC comprises at least one electrical management device DG configured to allow, on the one hand, an electrical power supply to the electrical star M1A, M1B, M2A, M2B by the associated power supply bus BUS1A, BUS1B, BUS2A, BUS2B and, on the other hand, an electrical power supply to the power supply bus BUS1A, BUS1B, BUS2A, BUS2B by the associated electrical star M1A, M1B, M2A, M2B. Preferably, each electrical management device DG comprises at least two pairs of switches that may be controlled in a coordinated manner. Each charge electrical line LC is sized to transmit the elementary power Pele. This allows to use traditional electrical lines.

Similarly, again with reference to FIG. 2, each power supply bus BUS1A, BUS1B, BUS2A, BUS2B is configured to be power supplied by a power supply output B1A, B2A, B1B, B2B via an electrical source line LS. Each electrical source line LS is dimensioned to transmit the elementary power Pele. This allows to use conventional electrical lines.

In this example, each power supply bus BUS1A, BUS1B, BUS2A, BUS2B is associated with a monitoring and isolation module K1A, K1B, K2A, K2B to allow a power supply bus BUS1A, BUS1B, BUS2A, BUS2B to be isolated in the event of a fault.

With reference to FIG. 2, the electrical distribution system 1 comprises an electrical reconfiguration line LR1 connecting the first commutator C1 to the second commutator C2. In this example, the electrical reconfiguration line LR1 connects the power supply buses BUS1B, BUS2A as shown in FIG. 2,

The electrical reconfiguration line LR1 comprises at least one reconfiguration switch 11 configured to be activate in the closed position in the event of a fault in one of the electrical sources B1, B2. This makes it advantageous to make the commutators C1, C2 independent, for example, when recharging the electrical sources B1, B2. This also allows the commutators C1, C2 to be connected together so as to form a global commutator for sharing the power received with the various electric motors M1, M2.

When the electrical distribution system 1 comprises more than two commutators C1, C2. several electrical reconfiguration lines are provided to allow power to be transferred between said commutators C1, C2.

Still referring to FIG. 2, the electrical distribution system 1 comprises a parking supply line LAP, connected to the electrical reconfiguration line LR1, which is configured to allow the recharging of the electrical sources B1, B2 via the commutators C1, C2 connected to the electrical reconfiguration line LR1. The reconfiguration switch 11 may therefore be closed to allow the simultaneous recharging of the two electrical sources B1, B2. This is particularly advantageous when the electrical sources B1, B2 are electrical batteries. The parking supply line LAP is configured to be connected to an airport power supply device, in particular a power supply electrical network EP.

An example of the implementation of a method for supplying the electric motors M1, M2 via the electrical distribution system 1 will now be presented.

In this example, the reconfiguration switch 11 is initially opened to electrically isolate the commutators C1, C2. The supply method comprises the steps consisting in:
for each commutator C1, C2, supplying power respectively to the first power supply bus BUS1A, BUS1B and the second power supply bus BUS2A, BUS2B via the first power supply output B1A, B2A and by the second supply output B1B, B2B of the electrical source B1, B2 associated with the commutator C1, C2,
for each commutator C1, C2, supplying power respectively to the first electrical star M1A, M2A and the second electrical star M1B, M2B of the electric motor M1, M2 associated with the commutator C1, C2 via the first power supply bus BUS1A, BUS1B and the second power supply bus BUS2A, BUS2B associated with the commutator C1, C2,
in the event of a fault in one of the electrical sources B1, B2, closing the reconfiguration switch T1 to electrically connect the commutators C1, C2.

Thus, thanks to the method described in the invention, the electrical distribution system 1 may provide a degraded operating mode wherein an electrical source B1, B2 allows to supply power to the two commutators C1, C2 to supply power to the two electric motors M1, M2. The use of electric motors M1, M2 with several stars allows an electric motor M1, M2 to be used in a degraded mode. This allows each electric motor M1, M2 to participate in propulsion in the event of a fault in an electrical source B1, B2. The use of several power supply buses, several electrical stars and several power supply outputs allows to use electrical sources B1, B2 with high nominal power Pnom while using traditional electrical lines that are less prone to electrical faults and less expensive.

The invention has been presented for supplying power to the electric motors M1, M2, but the invention also applies to the use of the electric motors M1, M2 as current generators for recharging the electrical sources B1, B2.

In the first embodiment shown in FIG. 2, each electrical source line LS comprises at least one source switch IS. Preferably, each source switch IS is controllable and may be used to open/close the electrical source line LS. A source switch LS may therefore be opened in the event of a fault in the power supply output connected to the electrical source line LS.

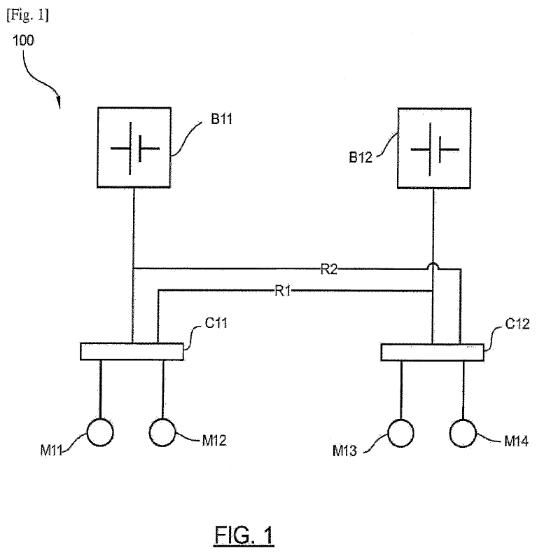

Still referring to FIG. 1, the power supply buses BUS1A, BUS1B, BUS2A, BUS2B of the same commutator C1, C2 are connected by an electrical connection line comprising a connection switch Z1, Z2 so as to allow them to be electrically connected together in a controllable manner. Such switches may be controlled by a monitoring device so as to isolate one or more electrical lines in order to isolate a fault, for example, a short-circuit.

In this first embodiment, a large number of switches may be reconfigured to isolate an electrical fault and allow an operation in a degraded mode.

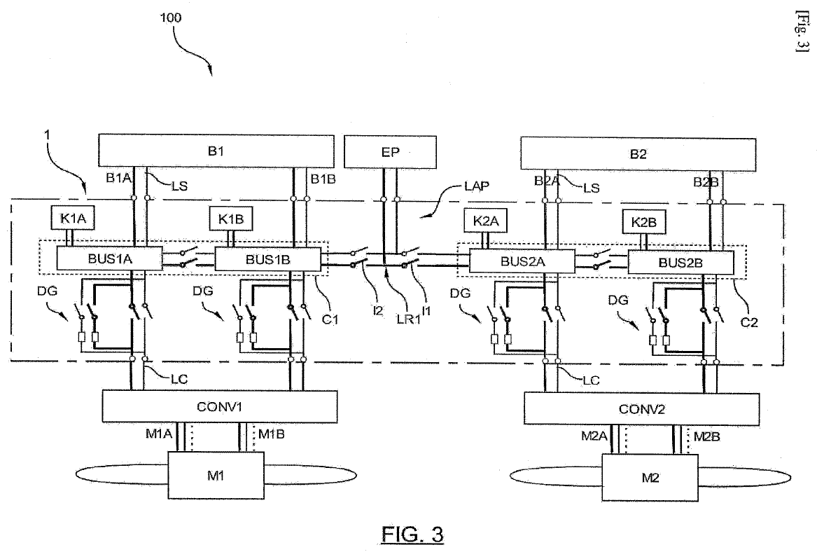

A second embodiment of the electrical distribution system 1 shown in FIG. 2 is shown in FIG. 3. For the sake of clarity and brevity, the electrical distribution system 1 will not be shown again. Only the differences compared with the first embodiment will be presented.

In the second embodiment shown in FIG. 3, each electrical source line LS has no source switch. In other words, the electrical source line LS is not controllable and provides a direct electrical supply. This advantageously allows to reduce the number of switches, which in turn reduces the cost and the overall dimension of the electrical distribution system 1. This significantly reduces the mass and limits the possibility of reconfiguration, as the occurrence of a fault on an electrical source line LS is low.

Still referring to FIG. 3, the electrical reconfiguration line LR1 comprises at least two reconfiguration switches I1, I2. The parking supply line LAP is connected between the two reconfiguration switches I1, I2. This allows the parking supply line LAP to recharge the electrical sources B1, B2 alternately or simultaneously, which is advantageous depending on the charge level of said electrical sources B1, B2. This makes the recharge more flexible.

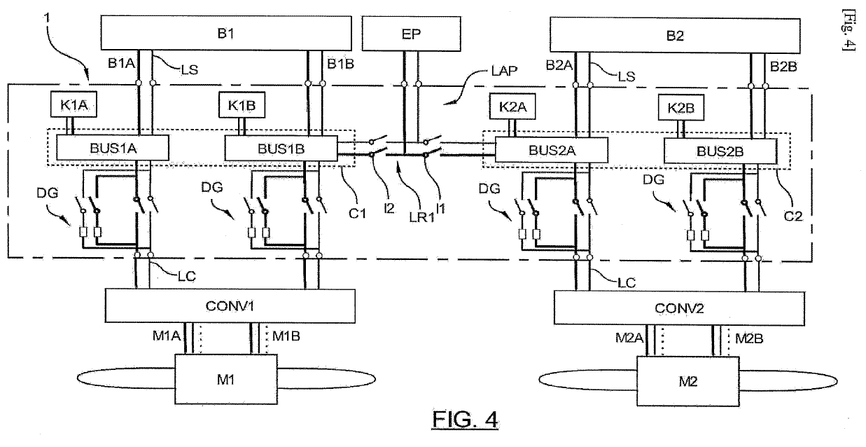

A third embodiment of the electrical distribution system 1 shown in FIG. 2 is shown in FIG. 4. For the sake of clarity and brevity, the electrical distribution system 1 will not be presented again. Only the differences compared with the second embodiment will be presented.

With reference to FIG. 4, the power supply buses of the same commutator C1, C2 are isolated from each other so as to limit the number of switches, which reduces the cost and the overall dimension of the electrical distribution system 1. This means that the electrical reconfiguration line may only connect two power supply buses BUS1B, BUS2A with different commutators C1, C2. The recharge via the parking supply line LAP is only possible via the two power supply buses BUS1B, BUS2A. Such an architecture is optimized because it allows an efficient distribution of electrical energy using traditional electrical lines, which are cheap to run. In addition, the number of switches is significantly reduced, which is advantageous in terms of weight, overall dimension, reliability and maintenance.

1. An electrical distribution system configured to supply power to at least a first electric motor and a second electric motor from at least a first electrical source and a second electrical source, each of the electric motor motors being a propulsion motor of an aircraft, each of the electric motors motor comprising at least a first electrical star and a second electrical star configured to be independently power supplied, each of the electrical sources having a defined nominal power, each of the electrical sources comprising at least a first power supply output and a second power supply output having a defined elementary power lower than the defined nominal power, the electrical distribution system comprising:
at least a first commutator and a second commutator, each of the commutators being associated with one of the electrical sources and one of the electric motors,
each of the commutators comprising at least a first power supply bus and a second power supply bus configured to supply power respectively to the first electrical star and the second electrical star of the electric motor associated with the commutator,
the first power supply bus and the second power supply bus of each of the commutators being configured to be power supplied respectively by the first power supply output and by the second power supply output of the electrical source associated with the commutator, the power supply buses being power supplied independently with the elementary power,
at least one electrical reconfiguration line connecting the first commutator to the second commutator, the electrical reconfiguration line comprising at least one reconfiguration switch configured to be active in a closed position in an event of a fault in one of the electrical sources.

2. The electrical distribution system according to claim 1, further comprising at least one parking supply line, connected to the electrical reconfiguration line, configured to allow the electrical sources to be recharged via the commutators connected to the electrical reconfiguration line.

3. The electrical distribution system according to claim 2, wherein the electrical reconfiguration line comprises at least two reconfiguration switches, the parking supply line being connected between the two reconfiguration switches.

4. The electrical distribution system according to claim 1, wherein each of the power supply busses being configured to be power supplied by a the power supply output via an electrical source line, each of the electrical source lines comprises at least one source switch.

5. The electrical distribution system according to claim 1, wherein each of the power supply busses are configured to supply power to the electrical star via an electrical charge line, each of the electrical charge lines comprises at least one electrical management device configured to allow, on the one hand, an electrical supply to the electrical star by the associated power supply bus and, on the other hand, an electrical power supply for supplying power to the power supply bus by the associated electrical star.

6. The electrical distribution system as claimed in claim 5, wherein the electrical management device comprises at least two pairs of switches that may be controlled in a coordinated manner.

7. The electrical distribution system according to claim 1, comprising a converter mounted between a commutator and the associated electric motor.

8. The electrical distribution system according to claim 1, wherein the power supply buses of the same commutator are isolated from each other.

9. An electrical architecture for an aircraft comprising at least a first electric motor and a second electric motor, at least a first electrical source and a second electrical source, each of the electric motors being a propulsion motor of an aircraft, each of the electric motors comprising at least a first electrical star and a second electrical star configured to be independently power supplied, each of the electrical sources having a defined nominal power, each of the electrical sources comprising at least a first power supply output and a second power supply output having a defined elementary power less than the defined nominal power, the architecture comprising at least one electrical distribution system according to claim 1 supplying power to the electrical motors from the electrical sources.

10. The architecture according to claim 9, wherein a sum of the elementary powers of the power supply outputs of the electrical source is greater than the nominal power of said electrical source.

11. A method for supplying power to at least a first electric motor and a second electric motor from at least a first electrical source and a second electrical source via an electrical distribution system according to claim 1, each of the electric motors being an aircraft propulsion motor, each of the electric motors comprising at least a first electrical star and a second electrical star configured to be power supplied independently, each of the electrical sources having a defined nominal power, each of the electrical sources comprising at least a first power supply output and a second power supply output having a defined elementary power lower than the defined nominal power the electrical sources being operational, the reconfiguration switch being open so as to electrically isolate the commutators, the supply method comprising:
for each commutator, supplying power respectively to the first power supply bus and the second power supply bus via the first power supply output and by the second power supply output of the electrical source associated with the commutator,
for reach commutator, supplying power respectively to the first electrical star and the second electrical star of the electric motor associated with the commutator, by the first power supply bus and the second power supply bus associated with the commutator.
if one of the electrical sources fails, closing the reconfiguration switch to electrically connect the commutators.
